(19) United States
(12) Patent Application Publication
(10) Pub. No.: US 2006/0245081 A1
(43) Pub. Date: Nov. 2, 2006

(54) Optical drive

(75) Inventor: Thomas John Mahony, Boulder, CO (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: BSI2000, Inc., Lakewood, CO (US)

(21) Appl. No.: 11/109,983

(22) Filed: Apr. 19, 2005

(51) Int. Cl. G02B 17/00

(52) U.S. Cl. 359/726

(57) ABSTRACT

An optical drive is provided with a substantially coherent light source and a collimation element to collimate a beam emanating from the light source. Beam-redirection elements redirect the collimated beam. Each beam-redirection element has noncollinear input and output axes for receiving light along the input axis and propagating the received light along the output axis. A first of the beam-redirection element is rotatable about a principal axis and a second of the beam-redirection elements is rotatable about the output axis of the first beam-redirection element. A focusing element focuses light emanating from the output axis of the second beam-redirection element onto a surface of the optical medium.

### BACKGROUND OF THE INVENTION

This application relates generally to an optical drive. More specifically, this application relates to an optical drive for an optical-card reader.

The development of optical cards has been relatively recent. They are cards that are typically made to be about the size of a standard credit card and which store digitized information in an optical storage area. One example of an optical card is described in U.S. Pat. No. 5,979,772, entitled “OPTICAL CARD” by Jiro Takei et al., the entire disclosure of which is incorporated herein by reference for all purposes. More generally, an “optical card” is used herein to refer to any medium on which data may be stored using optical storage techniques. Such optical cards are generally capable of storing very large amounts of data in comparison with magnetic-stripe or smart cards. For example, a typical optical card may compactly store up to 4 Mbyte of data, equivalent to about 1500 pages of typewritten information. As such, optical cards hold on the order of 1000 times the amount of information as a typical smart card. Unlike smart cards, optical cards are also impervious to electromagnetic fields, including static electricity, and they are not damaged by normal bending and flexing.

These properties of optical cards, particularly their large storage capacity, make them especially versatile for numerous different types of transactions. Merely by way of example, a single optical card could store fingerprint biometrics for all ten fingers, iris biometrics for both eyes, hand-geometry specifications for both hands, and a high-resolution color photograph of a cardholder while using far less than 1% of its capacity. This large storage capacity also allows information for essentially every transaction that involves the card to be written to the card and thereby provide a permanent detailed audit trail of the card's use.

To use the optical cards for transactions, methods and devices are needed that are capable of scanning over the surface of the optical medium of the optical card to extract information written there.

### BRIEF SUMMARY OF THE INVENTION

Embodiments of the invention thus provide optical drives and methods for reading encoded data on an optical medium. In one set of embodiments, described herein as rotationally centric beam-delivery embodiments, substantially coherent light is provided to the optical drive with a light source. A collimation element is disposed to collimate a beam emanating from the light source. A plurality of beam-redirection elements are provided to redirect the collimated beam. Each beam-redirection element has noncollinear input and output axes for receiving light along the input axis and propagating the received light along the output axis. A first of the beam-redirection element is rotatable about a principal axis and a second of the beam-redirection elements is rotatable about the output axis of the first beam-redirection element. A focusing element is disposed to focus light emanating from the output axis of the second beam-redirection element onto a surface of the optical medium.

In some embodiments, the optical medium is comprised by an optical card. The light source may be stationary relative to the optical medium and may provide substantially monochromatic light. The collimation element and/focusing element may comprise a lens in some embodiments. In addition, the collimation element and/or focusing element may be translatable, the collimation element along an optical axis of the collimation element and the focusing element along the output axis of the second beam-redirection element. In one embodiment, at least one of the beam-redirection elements comprises a prism, while in another embodiment, at least one of the beam-redirection elements comprises a plurality of mirrors.

Some embodiments have specific orientations of optical elements. For instance, in one embodiment, an optical axis of the collimation element is substantially orthogonal to the surface of the optical medium. In another embodiment, the output axis of each beam-redirection element is substantially parallel to the input axis of the each beam-redirection element. In a further embodiment, the output axis of the first beam-redirection element is substantially parallel to the principal axis.

In a second set of embodiments, referred to herein as radial beam-delivery embodiments, a light source is provided with a collimation element disposed to collimate a light beam emanating from the light source along a propagation axis. A translatable beam-redirection element redirects the beam. The beam-redirection element has noncollinear input and output axes for receiving light along the input axis and propagating the received light along the output axis. The input axis is substantially coincident with the propagation axis and the output axis intersects a surface of the optical medium. A focusing element is disposed to focus collimated light emanating from the output axis onto the surface of the optical medium.

The collimation and/or focusing element may comprise a lens. A variety of different structures may be provided for the beam-redirection element, including a mirror, a turning prism, a pentaprism, and a roofed pentaprism in different embodiments. Also, a variety of different orientations of optical elements may be used in different instances. In some such instances, the output axis may be substantially orthogonal to the surface of the optical medium. In other cases, the optical axis of the collimation element may be substantially parallel to the surface of the optical medium. In still other instances, the output axis may be substantially orthogonal to the input axis. In one embodiment, the beam-redirection element is translatable in a direction substantially parallel to the surface of the optical medium.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components. In some instances, a sublabel is associated with a reference numeral and follows a hyphen to denote one of multiple similar components. When reference is made to a reference numeral without specification to an existing sublabel, it is intended to refer to all such multiple similar components.

FIG. 1 provides a schematic illustration of a structure that may be used for an optical card;

FIG. 2 provides a perspective illustration of a transaction processing unit within which embodiments of the invention may be embodied;

FIGS. 3A and 3B provide schematic illustrations of different system arrangements that may be used to support the use of optical cards;

FIG. 4 provides a side view of an optical arrangement comprised by an optical drive in one embodiment of the invention;

FIG. 5 provides a side view of an optical arrangement comprised by an optical drive in another embodiment of the invention; and

FIGS. 6A and 6B provide perspective views of prism structures that may be used in optical arrangements in certain alternative embodiments of the invention.

### DETAILED DESCRIPTION OF THE INVENTION

1. Introduction: Optical-Card Networks

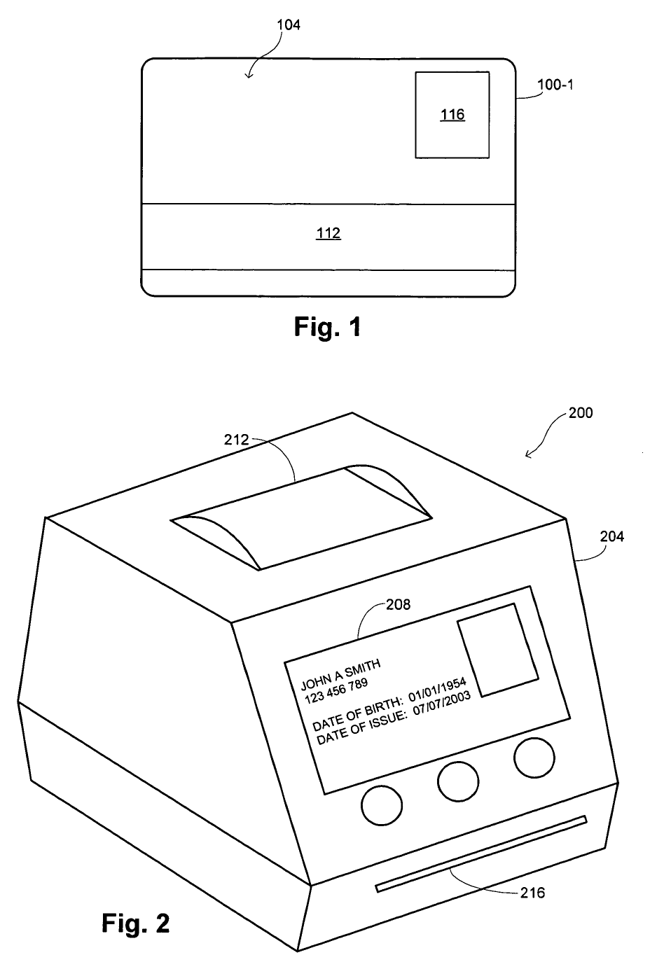

Embodiments of the invention provide methods and devices for reading information from an optical storage medium such as an optical card. FIG. 1 provides a diagram illustrating a structure for an optical card in one embodiment. The card 100 includes a cardholder photograph 116, an optical storage area 112, and a printed area 104 on one side of the card. The other side of the card could include other features, such as a bar code(s) or other optically recognizable code, a signature block, counterfeiting safeguards, and the like. The printed area 104 could include any type of information, such as information identifying the cardholder so that in combination with photograph 116 acts as a useful aid in authenticating a cardholder's identity. The printed area 104 could also include information identifying the issuer of the card, and the like. The optical storage area may also comprise a plurality of individual sections, which may be designated individually by an addressing system.

Many optical cards use a technology similar to the one used for compact discs (“CDs”) or for CD ROMs. For example, a panel of gold-colored laser-sensitive material may be laminated on the card and used to store the information. The material comprises several layers that react when a laser light is directed at them. The laser burns a small hole, about 2 μm in diameter, in the material; the hole can be sensed by a low-power laser during a read cycle. The presence or absence of the burn spot defines a binary state that is used to encode data. In some embodiments, the data can be encoded in a linear x-y format described in detail in the ISO/IEC 11693 and 11694 standards, the entire contents of which are incorporated herein by reference for all purposes.

According to embodiments of the invention, the sequence of encoding binary states may be read with an optical drive embodied within a transaction processing unit (“TPU”). One example of a structure for a TPU that may be used in some embodiments is provided in perspective view in FIG. 2. The TPU 200 includes a housing 204 within which a configuration of the optical drives described below may be provided. The TPU may include a card slot 216 adapted to accept an optical card so that data may be read from the optical card, a display screen 208 for displaying data about the optical card, and a printer 212 for generating hard copy.

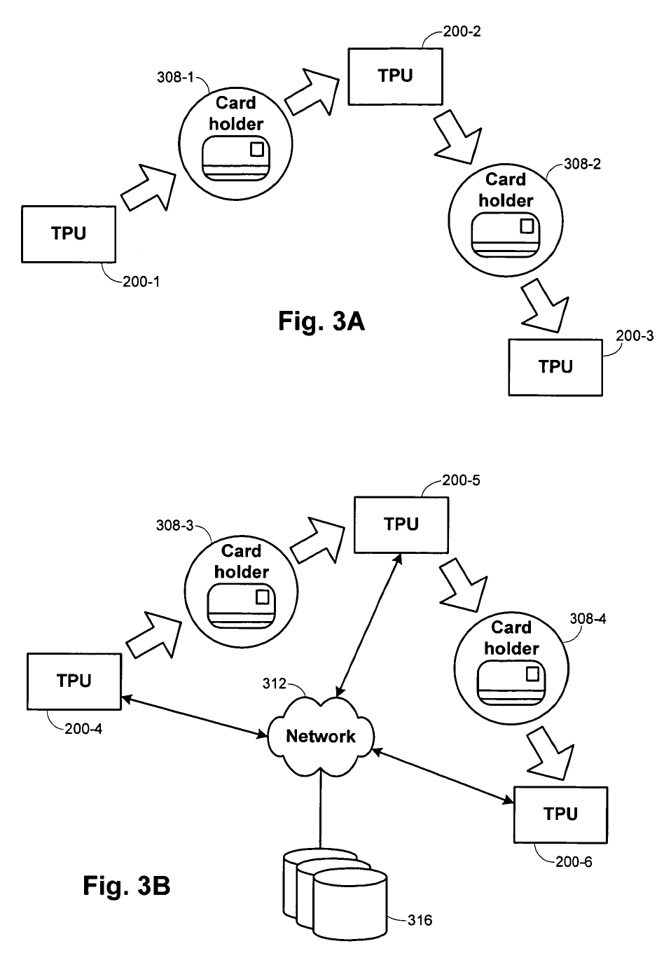

With a distribution of TPUs having the optical drive, the cards may be used as a mechanism for communicating information among the distribution. Optical cards may thus be used in a variety of different network structures, some of which avoid the large, complex, and expensive online systems that are inherently needed with smart cards. For example, FIG. 3A schematically illustrates a network in which a plurality of TPUs 200 are interconnected solely by optical cards. Transaction information is stored only on the optical cards carried by cardholders 308, rather being stored in any central or local database. Examples of different types of transactions that may be executed using the transaction information stored on the optical cards includes identification, financial, access, and numerous other types of transactions. For example, in one type of access transaction, a particular cardholder 208-1 may be granted access to a secure facility with that person's optical card including digitized identification and/or biometric information such as name, age, sex, record fingerprints, iris scans, and the like.

This ability to avoid storage of certain types of information, particularly in the context of avoiding storage in government databases, is especially valuable in addressing privacy concerns. Opposition to national identity cards and the like is often fueled by objections to providing government authorities with access to citizen biometric data; these objections may be largely obviated by storing such data on optical cards that remain under the control of the individuals whose information is stored.

Other types of information are not subject to the same types of privacy objections, and it may often be useful to store such information in a centralized database that is accessible to each of the TPUs 200. For instance, if the optical cards are used as identification to receive certain government benefits, a centralized database might record those benefits and the amounts that each individual is entitled to. This is more convenient than storing the information on the card because the amounts may change over time in response to cost-of-living or other adjustments made in the underlying programs. This may also be true of the specific access information in the example described above since a secure facility may reasonably wish to maintain its own records of who has been granted access. The system shown in FIG. 3B illustrates a system in which the TPUs are additionally connected with an electronic network 312 that has access to databases or other data-storage sources 316. The network may comprise the Internet or other wide-area network, a local-area network, a telephone network, and the like.

2. Optical Drive

In embodiments of the invention, the TPUs 200 in the network arrangements described above comprise an optical drive that allows the optical medium of optical cards to be scanned to extract the information stored thereon. These embodiments provide a light source, such as a laser source, with light from the source focused onto different portions of a surface of the optical medium depending on a state of the optical arrangement. In this way, the identification of the binary state associated with that position of the optical-medium surface may be determined. Scanning over the optical medium is achieved by moving through different states of the optical arrangement, the different states being achieved by motion of optical components comprised by the optical arrangement. In some embodiments, this motion comprises a combination of rotational motions about two axes; these embodiments are described below as rotationally centric beam-delivery embodiments. In other embodiments, the motion of the optical components takes the form of translational motion along an axis; the embodiments are described below as radial-beam-delivery embodiments.

In the embodiments described in detail below, the optical arrangements make use of “beam-redirection elements,” which refer herein to optical structures that cause a light beam propagating along an input axis to the element to be redirected to propagate along an output axis from the element that is noncollinear with the input axis. Thus, redirection elements may include reflective or refractive elements, or combinations of reflective and refractive elements, such as a mirror, an assembly of mirrors, a prism, a plurality of prisms, a combination of mirrors and prisms. The optical arrangements also comprise “collimation elements,” which act collimate a divergent beam of light and may thus include such components as lenses, curved mirrors, and the like. Similarly, the optical arrangements comprise “focusing elements,” which perform the inverse function of focusing a collimated beam of light and may thus also include such components as lenses, curved mirrors, and the like.

a. Rotationally Centric Beam-Delivery Embodiments

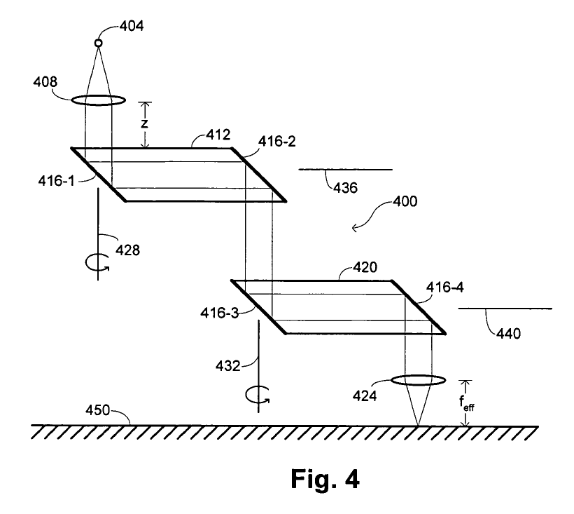

The optical arrangements used by certain rotationally centric beam-delivery embodiments include a plurality of beam-redirection elements, with a first of the beam-redirection elements being rotatable about a principal axis and a second of the beam-redirection elements being rotatable about the output axis of the first beam-redirection element. This is illustrated for a specific embodiment in FIG. 4, in which the beam-redirection elements comprise translating prisms. In FIG. 4, the optical medium to be examined by the optical drive is denoted by reference number 450. This optical medium may be comprised by an optical card in some embodiments, but may generally be any type of medium on which optically readable data have been encoded.

The optical drive includes a light source 404, which may comprise a monochromatic source like a laser, and light provided by the light source 404 is collimated by a collimation element, shown in this embodiment to be a lens. The optical arrangement 400 acts to move the beam so that it may be focused onto different parts of the surface of the optical medium 450. For ease of illustration, FIG. 4 shows a particular configuration for the optical arrangement 400 that may be considered to be an “in-line” configuration; this configuration is defined by respective states of translating prisms 412 and 420. The collimated light propagates along a principal axis 428 that coincides with the input axis of a first of the translating prisms 412. The first translating prism 412 comprises reflective ends 416 so that the incoming collimated beam is redirected out along the output axis 432 of the translating prism 412 to the second translating prism 420. The input axis of the second translating prism 420 is substantially coincident with the output axis of the first translating prism. The second translating prism 420 also comprises reflective ends 416 so that the incoming beam is again redirected, this time to a focusing element 424 that focuses the beam onto the surface of the optical medium. The first translating prism 412 is rotatable about the principal axis 428 and the second translating prism 420 is rotatable about the output axis 432 of the first translating prism 412. This provides two rotational degrees of freedom, allowing the light beam to be scanned to positions over the two-dimensional scope of the surface of the optical medium 450.

In some embodiments, one or both of the collimating and focusing elements may be translatable, allowing the system to compensate for variations in the height of the optical arrangement above the surface of the optical medium 450. For example, the effective focal length of the focusing lens 424 in the embodiment shown in FIG. 4 is denoted f_{eff}. If the focusing lens 424 is fixed relative to the optical arrangement, variations in height above the optical medium 450 may be accommodate through translation of the collimating lens 408 along the optical axis of the collimating lens 408. The movement of the collimating lens 408 results in movement of the focal point of the focusing lens, allowing for adjustment of f_{eff}. Similar considerations apply if the collimating lens 408 is fixed relative to the optical arrangement, so that accommodation for height variations may be made through translation of the focusing element along its optical axis.

The arrangement shown in FIG. 4 may be considered to be a “right-angles” arrangement because the beam is initially collimated in a direction orthogonal to the surface of the optical medium, and all redirections effected by the optical arrangement are in directions parallel to or orthogonal to the optical-medium surface. The invention is not limited to such a “right-angles” arrangement and in other embodiments, the paths followed by the optical beams may define arbitrary angles with the surface of the optical medium, provided that optical arrangement defines paths that focus light originating at the light source onto the optical-medium surface.

Furthermore, a number of aspects of the optical drive may reflect decisions made regarding a number of competing considerations. For instance, it may be desirable to limit the number of optical surfaces encountered by the beam because each encounter may contribute to degradation in optical performance and power delivered to the optical medium. In the embodiment illustrated in FIG. 4, eight optical surfaces are encountered within the optical arrangement between the collimation and focusing elements 408 and 424. This number may be reduced by replacing the translating prisms with pairs of mirrors in an embodiment. Other considerations in selecting embodiment for particular applications includes the sensitivity of the arrangement to mechanical rotations, including sensitivity to radial tilt, sensitivity to rotation about the focusing optical axis, sensitivity to rotation about the radial axis, and the like. In the embodiment of FIG. 4, for instance, the direction of the beam at the focusing lens 424 is substantially insensitive to movement of the prism 412 and 420 in and out of their plane of rotation. There is, however, sensitivity to twisting of the prisms 412 and 420 about their respective fundamental optical axes 436 and 440 as they operate at relatively high rotation rates. A further consideration is the cost of the optical arrangement, including not only the cost for the individual optical components, but also the cost of mounting the optical components in the desired configuration and with the desired kinematical capabilities. For example, the embodiment that uses pairs of mirrors instead of prisms may have a higher cost assembly associated with increased cost of mechanical mounting.

b. Radial Beam-Delivery Embodiments

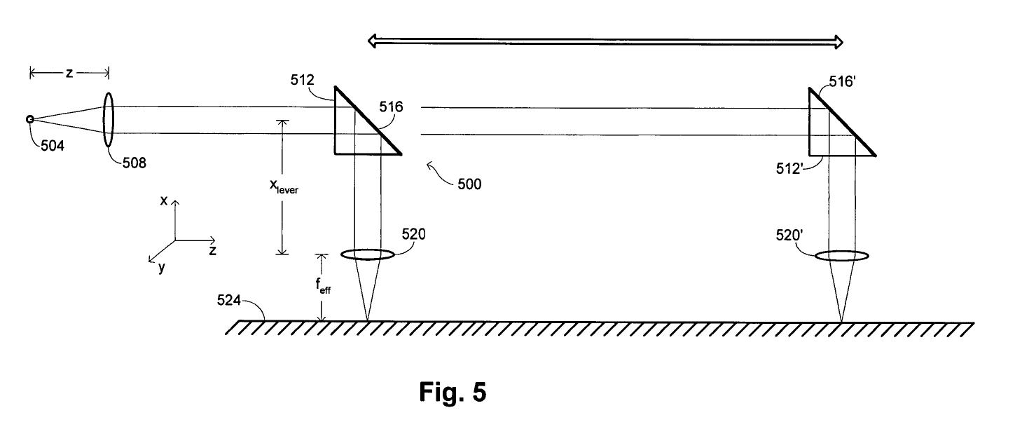

Embodiments that make use of radial beam delivery use a similar approach by providing a light source whose beam is collimated and redirected by an optical arrangement for focusing onto a surface of the optical medium by a focusing element. In these embodiments, however, the optical arrangement and focusing element are collectively translatable in a direction substantially parallel to the surface of the optical medium. One exemplary embodiment is illustrated in FIG. 5, in which the optical arrangement is provided with a turning prism 512 having a reflective surface 516. Light is provided by a light source 504 and collimated for propagation along the input axis of the turning prism 512 by a collimation element 508, shown to be a lens. Light output along an output axis of the turning prism 512 is focused onto a surface of the optical medium 524 by a focusing element 520, shown to be a lens. The turning prism 512 and focusing lens 520 are collectively translatable to different positions, as illustrated by the double-headed arrow and by a reproduction of these elements at a different position and denoted with primed reference numbers.

As in the rotationally centric beam-delivery embodiments, the light source may comprise a monochromatic light source, such as a laser. Also, certain embodiments may provide for one or both of the collimation and focusing elements 508 and 520 to be translatable along their respective optical axes. Such a capacity permits the effective focal length f_{eff} of the focusing element to be adjusted to compensate for changes in height above the surface of the optical medium 524. For instance, if the focusing element 520 is translatable only in the z direction and not at all in the x direction, the effective focal length f_{eff} may be adjusted by translation of the collimation element in the z direction.

Beam delivery from a radial point in this fashion reduces the complexity of the optical arrangement as compared with the rotationally centric beam-delivery embodiments, reducing the number of optical surfaces to three from eight in embodiments that use prisms. The number of optical surfaces may be further reduced to one in some embodiments by using a turning mirror instead of a turning prism, but the overall desirability of such embodiments is also influenced by other considerations such as sensitivity to mechanical motions, cost, and the like. The simplified geometry of the radial beam delivery also reduces the sensitivity to twisting of the turning prism 516 about the optical axis to the optical medium, i.e. in the x direction. This embodiment is, however, more sensitive to tilting of the mirror in the direction of the light source 504, i.e. in the z direction, and in the cross direction, i.e. in they direction. In both instances, angular rotations result in deviations in these directions proportional to f_{eff}+xₗₑᵥₑᵣ, where xₗₑᵥₑᵣ is the lever distance between the input axis of the turning prism 512 and the focusing element 520. In these directions, position errors equate to timing errors so that in certain embodiment electronic corrections are made for pointing errors.

As also noted for the rotationally centric beam-delivery embodiments, the illustration of a “right-angles” arrangement, with all beam paths being parallel or orthogonal to the surface of the optical medium 524, is not intended to be limiting. In other embodiments, the optical arrangements may be configured so that the optical paths make other angles with the surface.

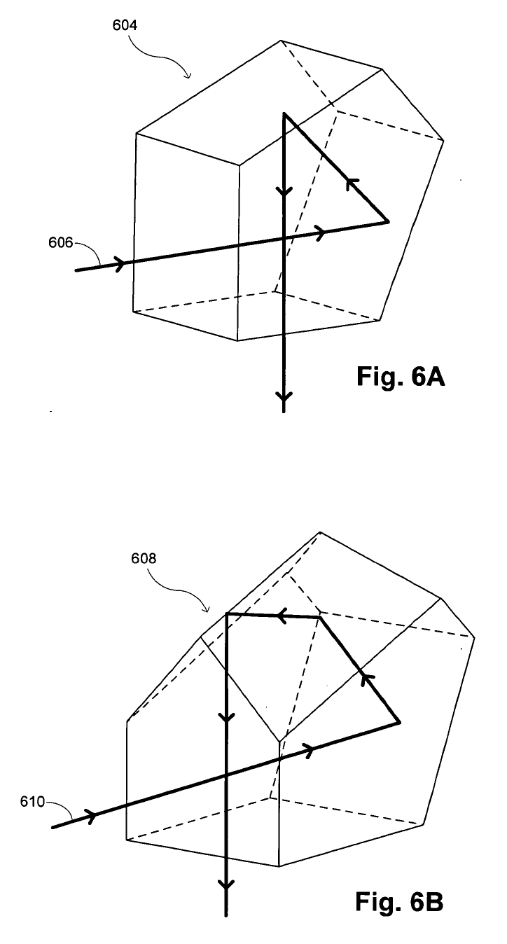

There are also a number of alternative optical arrangements that may advantageously be used instead of the turning prism or turning mirror in some radial beam-delivery embodiments. For example, in one embodiment, the optical arrangement comprises a pentaprism, an example of which is illustrated in FIG. 6A. The pentaprism 604 is a five-sided prism that commonly has four optical faces and one face that is left unworked. Two of the faces are provided at right angles, so that a beam 606 incident on a first of them is output orthogonally to its original path through the other of them. The arrangement of the other optical surfaces in the pentaprism is such that the orthogonal redirection of the beam is maintained irrespective of the orientation of the prism. Consequently, the sensitivity of the optical arrangement that comprises a pentaprism is comparable to the sensitivity with the rotationally centric beam-delivery. The cost of the reduction in sensitivity is an increase in the number of optical surfaces from three to four and an increase in the cost of implementation because of the shape of the pentaprism.

In still another embodiment, the optical arrangement may comprise a roofed pentaprism, an example of which is illustrated in FIG. 6B. The roofed pentaprism 608 has a shape similar to that of the pentaprism 604, except that the top surface of the pentaprism is replaced with a triangular roof reflector. The redirection characteristics of the roofed pentaprism 608 are similar to those of the pentaprism in that an incoming beam 610 is redirected to an orthogonal direction in a manner substantially insensitive to prism orientation. Use of the roofed pentaprism increases the number of optical surfaces encountered in the optical arrangement to five, although it will be evident that this number may be reduced by using mirrors instead of prisms, but with the optical surfaces in the same positions. Such a substitute in the case of the pentaprism reduces the number of optical surfaces to two, and reduces the number to three in the case of the roofed pentaprism, although in both cases the manufacturing costs are greater because of the additional complexity in mounting the mirror arrangements.

Having described several embodiments, it will be recognized by those of skill in the art that various modifications, alternative constructions, and equivalents may be used without departing from the spirit of the invention. Accordingly, the above description should not be taken as limiting the scope of the invention, which is defined in the following claims.

What is claimed is:

1. An optical drive for reading data encoded on an optical medium, the optical drive comprising:
a substantially coherent light source;
a collimation element disposed to collimate a light beam emanating from the light source;
a plurality of beam-redirection elements, each such beam-redirection element having noncollinear input and output axes for receiving light along the input axis and propagating the received light along the output axis, wherein a first of the beam-redirection elements is rotatable about a principal axis and a second of the beam-redirection elements is rotatable about the output axis of the first beam-redirection element; and
a focusing element disposed to focus collimated light emanating from the output axis of the second beam-redirection element onto a surface of the optical medium.

2. The optical drive recited in claim 1 wherein the optical medium is comprised by an optical card.

3. The optical drive recited in claim 1 wherein the light source is stationary relative to the optical medium.

4. The optical drive recited in claim 1 wherein the collimation element comprises a lens.

5. The optical drive recited in claim 1 wherein the collimation element is translatable along an optical axis of the collimation element.

6. The optical drive recited in claim 1 wherein the focusing element comprises a lens.

7. The optical drive recited in claim 1 wherein the focusing element is translatable along the output axis of the second beam-redirection element.

8. The optical drive recited in claim 1 wherein at least one of the plurality of beam-redirection elements comprises a prism.

9. The optical drive recited in claim 1 wherein at least one of the plurality of beam-redirection elements comprises a plurality of mirrors.

10. The optical drive recited in claim 1 wherein an optical axis of the collimation element is substantially orthogonal to the surface of the optical medium.

11. The optical drive recited in claim 1 wherein the output axis of each beam-redirection element is substantially parallel to the input axis of the each beam-redirection element.

12. The optical drive recited in claim 1 wherein the light source comprises a substantially monochromatic light source.

13. The optical drive recited in claim 1 wherein the output axis of the first beam-redirection element is substantially parallel to the principal axis.

14. A method for reading data encoded on an optical medium, the method comprising:
propagating a substantially coherent light beam from a light source;
collimating the light beam along a first axis;
redirecting the light beam from propagation along the first axis to propagation along an intermediate axis in accordance with a state of a first beam-redirection element;
redirecting the light beam from propagation along the intermediate axis to propagation along a second axis in accordance with a state of a second beam-redirection element, each of the first and second beam-redirection elements having noncollinear input and output axes for receiving light along the input axis and propagating the received light along the output axis;
focusing the beam onto a surface of the optical medium; and
changing the state of at least one of the first and second beam-redirection elements to change a position of the second axis relative to the first axis.

15. The method recited in claim 14 wherein changing the state of the at least one of the first and second beam-redirection elements changes a position of the second axis relative to the intermediate axis.

16. The method recited in claim 14 wherein changing the state of the at least one of the first and second beam-redirection elements changes a position of the intermediate axis relative to the first axis.

17. The method recited in claim 14 wherein the light beam is substantially monochromatic.

18. The method recited in claim 14 wherein the intermediate axis is substantially parallel to the first axis.

19. The method recited in claim 18 wherein the intermediate axis is substantially parallel to the second axis.

20. The method recited in claim 14 wherein the first axis is substantially parallel to the second axis.

21. The method recited in claim 14 wherein changing the state of the at least one of the first and second beam-redirection elements comprises rotating the at least one of the first and second beam-redirection elements about an axis parallel to one of the input and output axes of the at least one of the first and second beam-redirection elements.

22. The method recited in claim 21 wherein changing the state of the at least one of the first and second beam-redirection elements comprises:
rotating the first beam-redirection element about an axis parallel to one of the input and output axes of the first beam-redirection element; and
rotating the second beam-redirection element about an axis parallel to one of the input and output axes of the second beam-redirection element.

23. An optical drive for reading data encoded on an optical medium, the optical drive comprising:
means for propagating a substantially coherent light beam;
means for collimating the light beam along a first axis;
first means for redirecting the light beam from propagation along the first axis to propagation along an intermediate axis in accordance with a state of the first means for redirecting;
second means for redirecting the light beam from propagation along the intermediate axis to propagation along a second axis in accordance with a state of the second means for redirecting;
means for focusing the beam onto a surface of the optical medium; and
means for changing the state of at least one of the first and second means for redirecting.

24. An optical drive for reading data encoded on an optical medium, the optical drive comprising:
a substantially coherent light source;
a collimation element disposed to collimate a light beam emanating from the light source along a propagation axis;
a beam-redirection element having noncollinear input and output axes for receiving light along the input axis and propagating the received light along the output axis, wherein the input axis is substantially coincident with the propagation axis and the output axis intersects a surface of the optical medium; and
a focusing element disposed to focus collimated light emanating from the output axis onto the surface of the optical medium,
wherein the beam-redirection element and focusing element are collectively translatable in a direction substantially parallel to the surface of the optical medium.

25. The optical drive recited in claim 24 wherein the output axis is substantially orthogonal to the surface of the optical medium.

26. The optical drive recited in claim 24 wherein the optical medium is comprised by an optical card.

27. The optical drive recited in claim 24 wherein the light source is stationary relative to the optical medium.

28. The optical drive recited in claim 24 wherein the collimation element comprises a lens.

29. The optical drive recited in claim 24 wherein the collimation element is translatable along an optical axis of the collimation element.

30. The optical drive recited in claim 24 wherein the focusing element comprises a lens.

31. The optical drive recited in claim 24 wherein the beam-redirection element comprises a mirror.

32. The optical drive recited in claim 24 wherein the beam-redirection element comprises a turning prism.

33. The optical drive recited in claim 24 wherein the beam-redirection element comprises a pentaprism.

34. The optical drive recited in claim 24 wherein an optical axis of the collimation element is substantially parallel to the surface of the optical medium.

35. The optical drive recited in claim 24 wherein the output axis is substantially orthogonal to the input axis.

36. The optical drive recited in claim 24 wherein the beam-redirection element is translatable in a direction substantially parallel to the surface of the optical medium.

37. A method for reading data encoded on an optical medium, the method comprising:
propagating a substantially coherent light beam from a light source;
collimating the light beam along a propagation axis;
redirecting the light beam from propagation along the propagation axis to propagation along an output axis that intersects a surface of the optical medium in accordance with a state of a beam-redirection element;
focusing the beam onto a surface of the optical medium; and
changing the state of the beam-redirection element by translating the beam-direction element over the surface of the optical medium.

38. The method recited in claim 37 wherein the output axis is substantially orthogonal to the surface of the optical medium.

39. The method recited in claim 37 wherein translating the beam-direction element comprises translating the beam-direction element along the propagation axis.

40. The method recited in claim 39 wherein the propagation axis is substantially parallel to the surface of the optical medium.

41. The method recited in claim 37 wherein the output axis is substantially orthogonal to the propagation axis.

42. The method recited in claim 37 wherein the light beam is substantially monochromatic.

43. An optical drive for reading data encoded on an optical medium, the optical drive comprising:
means for propagating a substantially coherent light beam;
means for collimating the light beam along a propagation axis;
means for redirecting the light beam from propagation along the propagation axis to propagation along an output axis that intersects a surface of the optical medium in accordance with a state of the means for redirecting;
means for focusing the beam onto a surface of the optical medium; and
means for changing the state of the means for redirecting by translating the means for redirecting over the surface of the optical medium.
